(19) United States
(12) Patent Application Publication
(10) Pub. No.: US 2025/0142326 A1
(43) Pub. Date: May 1, 2025

(54) AUTHENTICATION OF A WIRELESS COMMUNICATION DEVICE WITH AN EXTERNAL AUTHENTICATION SERVER

(71) Applicant: TELEFONAKTIEBOLAGET LM ERICSSON (PUBL), STOCKHOLM (SE)

(72) Inventors: Cheng Wang, Shanghai (SE); David CASTELLANOS ZAMORA, MADRID (ES); Helena Vahidi Mazinani, LUND (SE)

(21) Appl. No.: 18/693,659

(22) PCT Filed: Sep. 15, 2022
(86) PCT No.: PCT/EP2022/075628

§ 371 Date: Mar. 20, 2024

(30) Foreign Application Priority Data
Sep. 20, 2021 (WO) PCT/CN2021/119480

(51) Int. Cl. H04W 12/06; H04W 12/084; H04W 12/72

(52) U.S. Cl. CPC H04W 12/06; H04W 12/084; H04W 12/72

(57) ABSTRACT

An authentication server (14) is configured for use in a wireless communication network (10). The authentication server (14) initiates primary authentication of a wireless communication device (12) with an external authentication server (20) that is external to the wireless communication network (10). The authentication server (14) further receives signaling (24) that indicates the primary authentication of the wireless communication device (12) with the external authentication server (20) succeeded and that includes an identifier (26) asserted by the external authentication server (20) as authentically identifying the wireless communication device (12). The authentication server (14) authenticates the wireless communication device (12) with the wireless communication network (10) based on the identifier (26) included in the received signaling (24).

### TECHNICAL FIELD

The present application relates generally to a wireless communication network, and relates more particularly to authentication of a wireless communication device with an external authentication server external to the wireless communication network.

### BACKGROUND

A wireless communication network performs a procedure for authenticating and authorizing a wireless communication device as a prerequisite for providing wireless communication server to that device. In some cases, such as where the wireless communication network is a standalone non-public network (SNPN), the wireless communication network may support authentication and authorization of a wireless communication device based on credentials from an external authorization server that is external to the wireless communication network, i.e., in a Credentials Holder (CH). Such authentication and authorization may be referred to as primary authentication and authorization, i.e., it is not secondary as may be the case for network slice specific authentication and authorization.

Challenges exist, though, in exploiting external authentication and authorization while also preserving identifier privacy. For example, challenges exist in exploiting external authentication when a wireless communication device triggers primary authentication using an anonymous identifier in order to preserve privacy.

### SUMMARY

Some embodiments herein facilitate authentication of a wireless communication device with an external authentication server that is external to a wireless communication network. According to some embodiments, the external authentication server sends, to the wireless communication network, an identifier asserted by the external authentication server as authentically identifying the wireless communication device, e.g., an identifier that is, or is associated with, the identifier authenticated by the external authentication server. The wireless communication network may then authenticate the wireless communication device with the wireless communication network based on that asserted identifier. This way, even if the wireless communication device triggers authentication using an anonymous identifier, the wireless communication network can still learn of a non-anonymous identifier for the wireless communication device after authentication. Some embodiments thereby advantageously facilitate external authentication while also preserving identifier privacy.

More particularly, embodiments herein include a method performed by an authentication server in a wireless communication network. The method comprises initiating primary authentication of a wireless communication device with an external authentication server that is external to the wireless communication network. The method also comprises receiving signaling that indicates the primary authentication of the wireless communication device with the external authentication server succeeded and that includes an identifier asserted by the external authentication server as authentically identifying the wireless communication device. The method in some embodiments further comprises authenticating the wireless communication device with the wireless communication network based on the identifier included in the received signaling.

In some embodiments, initiating primary authentication comprises initiating primary authentication of the wireless communication device with the external authentication server using an anonymous identifier that does not identify the wireless communication device. In one such embodiment, the identifier included in the received signaling is a non-anonymous identifier. For example, in some embodiments, the anonymous identifier is an anonymous Subscription Permanent Identifier, SUPI, and the non-anonymous identifier is a non-anonymous SUPI.

Alternatively or additionally, initiating primary authentication may comprise initiating primary authentication of the wireless communication device with the external authentication server using a presented identifier that the wireless communication device has presented as identifying the wireless communication device to the wireless communication network. In this case, authenticating the wireless communication device with the wireless communication network based on the identifier included in the received signaling may comprise confirming that the presented identifier corresponds to the identifier included in the received signaling. In one embodiment, such confirming comprises transmitting the presented identifier to network equipment implementing a Unified Data Management, UDM, function, and performing said confirming based on a response received from the network equipment implementing the UDM function.

In some embodiments, the primary authentication is initiated as part of a procedure for registering the wireless communication device with the wireless communication network. In one such embodiment, the method further comprises registering the wireless communication device with the wireless communication network based on successful authentication of the wireless communication device with the wireless communication network.

In some embodiments, the wireless communication network is a standalone non-public network.

Embodiments herein also include a method performed an external authentication server external to a wireless communication network. The method comprises performing primary authentication of a wireless communication device with the external authentication server for access by the wireless communication device to the wireless communication network. The method further comprises transmitting, to an authentication server in the wireless communication network, signaling that indicates the primary authentication of the wireless communication device with the external authentication server succeeded and that includes an identifier asserted by the external authentication server as authentically identifying the wireless communication device.

In some embodiments, the method further comprises receiving signaling that triggers the external authentication server to perform the primary authentication of the wireless communication device with the external authentication server. In one such embodiment, the signaling includes an anonymous identifier for the wireless communication device. In some embodiments, for example, the anonymous identifier is an anonymous Subscription Permanent Identifier, SUPI.

In some embodiments, the identifier included in the transmitted signaling is a non-anonymous identifier. In one such embodiment, the non-anonymous identifier is a non-anonymous SUPI.

In some embodiments, the wireless communication network is a standalone non-public network.

Embodiments herein further include a method performed by a network node in a wireless communication network. The method comprises receiving, from an authentication server in the wireless communication network, a request for primary authentication of a wireless communication device with an external authentication server for access by the wireless communication device to the wireless communication network. The method further comprises transmitting, to the authentication server in the wireless communication network, a response that indicates the primary authentication of the wireless communication device with the external authentication server succeeded and that includes an identifier asserted by the external authentication server as authentically identifying the wireless communication device.

In some embodiments, the request includes an anonymous identifier for the wireless communication device, and the identifier included in the transmitted signaling is a non-anonymous identifier. In one embodiment, for example, the anonymous identifier is an anonymous Subscription Permanent Identifier, SUPI, and the non-anonymous identifier is a non-anonymous SUPI.

In some embodiments, the wireless communication network is a standalone non-public network.

In some embodiments, the authentication server implements an Authentication Server Function, AUSF, and/or the network node implements a Network Slice-Specific Authentication and Authorization Function, NSSAAF.

Embodiments herein also include a method performed by a network node in a wireless communication network. The method comprises receiving, from an authentication server in the wireless communication network, a request for authentication data for a wireless communication device. The method further comprises transmitting, to the authentication server, a response that indicates primary authentication of the wireless communication device is to be run with an external authentication server external to the wireless communication network and that includes an identifier to be presented to the external authentication server.

In some embodiments, the request includes an anonymous identifier for the wireless communication device, and the identifier included in the response is the anonymous identifier for the wireless communication device. In one embodiment, for example, the anonymous identifier is an anonymous Subscription Permanent Identifier, SUPI.

In some embodiments, the method further comprises deciding, based on a realm part of the anonymous identifier, that primary authentication of the wireless communication device is to be run with the external authentication server external to the wireless communication network.

In some embodiments, the wireless communication network is a standalone non-public network.

Embodiments herein also include corresponding apparatus, computer programs, and carriers of those computer programs.

For example, embodiments herein include an authentication server configured for use in a wireless communication network. The authentication server comprising communication circuitry and processing circuitry. The processing circuitry is configured to initiate primary authentication of a wireless communication device with an external authentication server that is external to the wireless communication network, receive signaling that indicates the primary authentication of the wireless communication device with the external authentication server succeeded and that includes an identifier asserted by the external authentication server as authentically identifying the wireless communication device, and authenticate the wireless communication device with the wireless communication network based on the identifier included in the received signaling.

Embodiments herein also include an external authentication server external to a wireless communication network. The external authentication server comprises communication circuitry and processing circuitry. The processing circuitry is configured to perform primary authentication of a wireless communication device with the external authentication server for access by the wireless communication device to the wireless communication network, and to transmit, to an authentication server in the wireless communication network, signaling that indicates the primary authentication of the wireless communication device with the external authentication server succeeded and that includes an identifier asserted by the external authentication server as authentically identifying the wireless communication device.

Embodiments herein further include a network node configured for use in a wireless communication network. The network node comprises communication circuitry and processing circuitry. The processing circuitry is configured to receive, from an authentication server in the wireless communication network, a request for primary authentication of a wireless communication device with an external authentication server for access by the wireless communication device to the wireless communication network. The processing circuitry is also configured to transmit, to the authentication server in the wireless communication network, a response that indicates the primary authentication of the wireless communication device with the external authentication server succeeded and that includes an identifier asserted by the external authentication server as authentically identifying the wireless communication device.

Embodiments herein further include a network node configured for use in a wireless communication network. The network node comprises communication circuitry and processing circuitry. The processing circuitry is configured to receive, from an authentication server in the wireless communication network, a request for authentication data for a wireless communication device, and to transmit, to the authentication server, a response that indicates primary authentication of the wireless communication device is to be run with an external authentication server external to the wireless communication network and that includes an identifier to be presented to the external authentication server.

### BRIEF DESCRIPTION OF THE DRAWINGS

FIG. 1 is a block diagram of a wireless communication network 10 according to some embodiments.

FIG. 2 is a block diagram of authentication via a Credential Holder in a 5GS according to some embodiments.

FIG. 3 is a call flow diagram of authentication with an external authentication server according to some embodiments.

FIG. 4 is a call flow diagram of authentication with an external authentication server according to some embodiments where a wireless communication device uses an anonymous identifier.

FIG. 5 is a call flow diagram of authentication with an external authentication server according to some embodiments where a wireless communication device uses a non-anonymous identifier.

FIG. 6 is a logic flow diagram of a method performed by an authentication server according to some embodiments.

FIG. 7 is a logic flow diagram of a method performed by an external authentication server according to some embodiments.

FIG. 8 is a logic flow diagram of a method performed by a network node (e.g., implementing an NSSAAF) according to some embodiments.

FIG. 9 is a logic flow diagram of a method performed by a network node (e.g., implementing a UDM) according to some embodiments.

FIG. 10 is a block diagram of an authentication server according to some embodiments.

FIG. 11 is a block diagram of an external authentication server according to some embodiments.

FIG. 12 is a block diagram of a network node (e.g., implementing an NSSAAF) according to some embodiments.

FIG. 13 is a block diagram of a network node (e.g., implementing a UDM) according to some embodiments.

FIG. 14 is a block diagram of a communication system according to some embodiments.

FIG. 15 is a block diagram of a user equipment according to some embodiments.

FIG. 16 is a block diagram of a network node according to some embodiments.

FIG. 17 is a block diagram of a host according to some embodiments.

FIG. 18 is a block diagram of a virtualization environment according to some embodiments.

### DETAILED DESCRIPTION

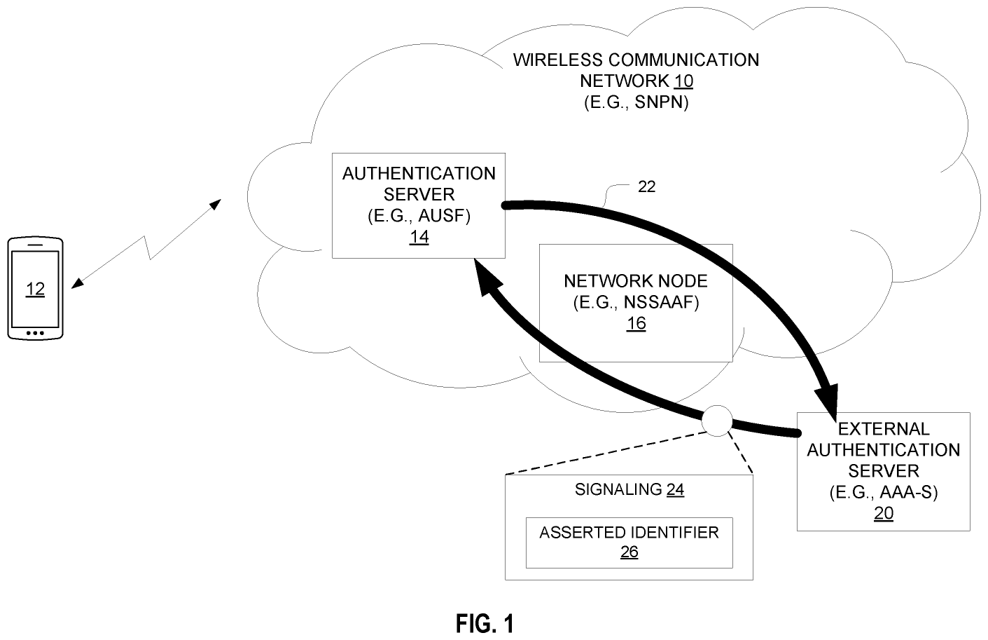

FIG. 1 shows a wireless communication network 10 according to some embodiments. In some embodiments, the wireless communication network 10 is a standalone non-public network (SNPN). Regardless, the wireless communication network 10 is configured to provide wireless communication service to a wireless communication device 12, e.g., that has a subscription to the wireless communication network 10. As a pre-requisite to providing such service to the wireless communication device 12, the wireless communication network 10 is configured to authenticate and authorize the wireless communication device 12, e.g., as part of a procedure for registering the wireless communication device 12 with the wireless communication network 10.

As shown in this regard, an authentication server 14 in the wireless communication network 10 is configured to initiate primary authentication of the wireless communication device 12 with an external authentication server 20 that is external to the wireless communication network 10. The external authentication server 20 may for example be outside the control and/or management of the wireless communication network's operator. In some embodiments, the authentication server 14 initiates such primary authentication via one or more other network nodes 16 in the wireless communication network 10. As shown, for instance, the authentication server 14 transmits an authentication request 22 to a network node 16, e.g., implementing a Network Slice-Specific Authentication and Authorization Function (NSSAAF). In this case, the authentication request 22 may indicate or request primary authentication is to be performed with an external network, and the network node 16 may select the external authentication server 20 for such purpose.

The authentication server 14 according to some embodiments receives signaling 24 in response to the authentication request 22, e.g., via the network node 16. The signaling 24 indicates the primary authentication of the wireless communication device 12 with the external authentication server 20 succeeded. Notably, the signaling 24 also includes an identifier 26 asserted by the external authentication server 20 as authentically identifying the wireless communication device 12. For example, in some embodiments, the asserted identifier 26 is the identifier actually authenticated by the external authentication server 20 as identifying the wireless communication device 12. The identifier 26 may for example be an Extensible Authentication Protocol (EAP) ID. In other embodiments, the asserted identifier 26 may be associated with the identifier actually authenticated by the external authentication server 20 as identifying the wireless communication device 12. The identifier 26 may for example be a public identifier (e.g., a Generic Public Subscription Identifier, GPSI) mapped to the EAP ID. Either way, the asserted identifier 26 identifies the wireless communication device 12, e.g., in a non-anonymous manner.

The authentication server 14 in some embodiments may thereby authenticate the wireless communication device 12 with the wireless communication network 10 based on the identifier 26 included in the received signaling 24.

Notably, by the external authentication server 20 providing the asserted identifier 26 to the authentication server 14 in the wireless communication network 10, some embodiments enable authentication even if the wireless communication device 12 initiates primary authentication using an anonymous identifier, e.g., an anonymous Subscription Concealed Identifier (SUCI) or anonymous Subscription Permanent Identifier (SUPI). Indeed, if the wireless communication device 12 initiates primary authentication using an anonymous identifier, the authentication server 14 according to embodiments herein learns the non-anonymous identity of the wireless communication device 12 from the external authentication server 20 (by the external authentication server 20 informing the authentication server 14 of the asserted identifier 26) and is thereby able to authenticate the wireless communication device 12 with the wireless communication network 10.

Consider now an example of some embodiments where the wireless communication network 10 is exemplified as a standalone non-public network (SNPN), where the wireless communication device 12 is exemplified as a user equipment (UE), where the authentication server 14 is exemplified as implementing an Authentication Server Function (AUSF), and where the external authentication server 20 is exemplified as implementing an Authentication Authorization Accounting Server (AAA-S).

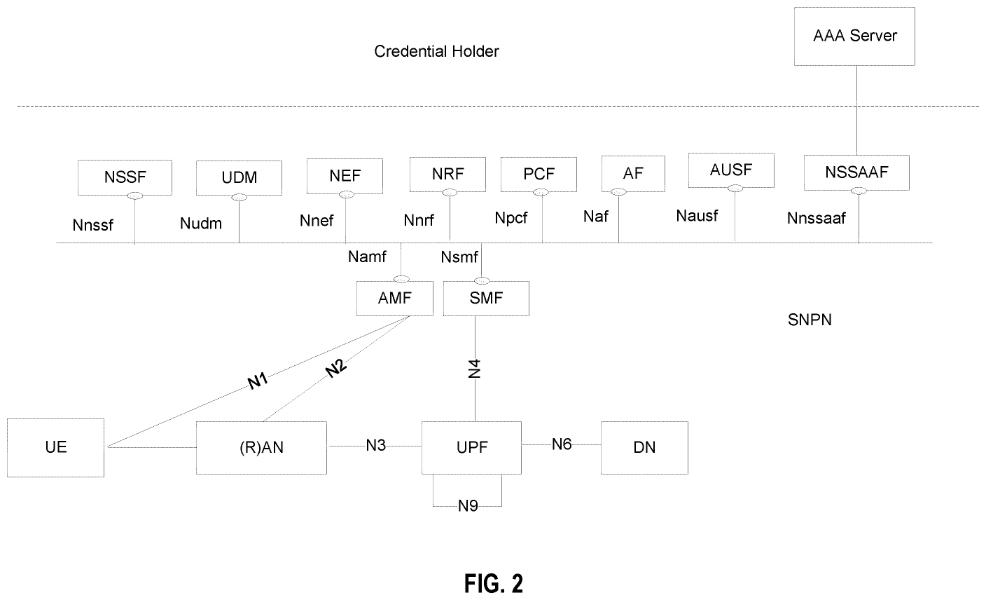

SNPNs support UE access using credentials owned by a Credentials Holder separate from the SNPN. The AUSF in an SNPN may support primary authentication and authorization of UEs that use credentials from an AAA Server in a Credentials Holder (CH). FIG. 2 depicts the 5G System architecture for SNPN with Credentials Holder using an AAA Server for primary authentication and authorization.

If the Unified Data Management (UDM) decides that the primary authentication is performed by the AAA Server in the CH based on UE subscription data and the UE's SUPI, which is de-concealed by the UDM from the SUCI received from the AUSF, then the UDM instructs the AUSF that primary authentication by a AAA server in a CH is required. The AUSF shall discover and select the NSSAAF, and then forward EAP messages to the NSSAAF. The NSSAAF selects the AAA Server based on the domain name corresponding to the realm part of the SUPI, relays EAP messages between AUSF and AAA Server (or AAA proxy) and performs related protocol conversion. The AAA server acts as the EAP Server for the purpose of primary authentication.

The SUPI is used to identify the UE during primary authentication and authorization towards the AAA sever. The Access and Mobility Function (AMF) and the Session Management Function (SMF) shall retrieve the UE subscription data from the UDM using the SUPI.

If the UE provides a SUCI based on a SUPI which can be de-concealed by the UDM at the SNPN, the resulting SUPI can be then provided to the AAA-S via the AUSF. In this case, the SUPI is used between the AUSF at the SNPN and the AAA-S at the CH to identify the UE during the primary authentication procedure.

However, the UE may on the other hand provide an “anonymous SUCI” during the UE registration which triggers the primary authentication procedure, e.g., as described in 3GPP TS 33.501 v17.2.1 which define the use of Extensible Authentication Protocol (EAP)-Transport Layer Security (TLS) for primary authentication. Such may be the case in a 5G System (5GS), e.g., as described in informative Annex B of TS 33.501 v17.2.1, or in the context of Non-5G Capable (N5GC) devices behind Residential Gateways (RGs) in private networks or in isolated deployment scenarios with wireline access, e.g., as described in informative Annex O of TS 33.501 v17.2.1. Regardless, in such embodiments, during the UE registration that triggers the primary authentication procedure, the UE makes use of a SUPI/SUCI, which omits the username part from the Network Access Identifier (NAI) (referred to hereafter as “anonymous SUPI/SUCI”).

Nevertheless, the “null-scheme” could be used in the Non-Access Stratum (NAS) layer while still preserving subscription identifier privacy, by omitting the username part from NAI as described in RFC 4282 clause 2.3. It would be analogous to using an anonymous identifier in EAP, meaning that only the realm part from NAI is included in SUCI which is sent in NAS layer. Thus, the formed SUCI can still be used to route the authentication request to AUSF.

In such cases where an anonymous identifier is used, the UDM is not capable to resolve any SUPI for the anonymous SUCI provided by the UE and it is responsible for the AUSF acting as EAP server to request the SUPI from the UE during the EAP-TLS execution. If the SUPI received from the UDM is anonymous, the AUSF derives the SUPI from the client identifier in the TLS client certificate.

Some embodiments make the AUSF/UDM in the SNPN aware of the UE's SUPI even in this case where an anonymous identifier is used, i.e., even when the EAP server role is provided by the AAA-S in the CH instead of by the AUSF.

Some embodiments also provide for the possibility that the SUPI of the UE in the SNPN could be exchanged with the external AAA server from the CH. It is expected that when the SNPN and the CH belong to the same organization, it will be acceptable to use the SUPI as the user identifier for the EAP authentication under control of the AAA-S in the CH. However, the CH may be provided by a different organization than the SNPN and even the CH may provide its services to multiple SNPNs. Then, depending on the trust relationship between the CH/AAA-S and the SNPN, there could be cases requiring that the user identifier used by the AAA-S in CH during primary authentication procedure is not the SUPI used within the SNPN for the rest of procedures.

According to embodiments herein, in the case the UE applies an anonymized SUCI when registering in the SNPN, the AUSF/UDM in the SNPN cannot learn the UE's actual SUPI based on the initial message from the UE. It is only after a performed authentication between the UE and the AAA of the CH that the AAA learns the identity of the UE (UE ID). The UE ID in some embodiments is returned to the AUSF together with a successful authentication result. Then the UDM/AUSF learn the SUPI from the UE ID.

According to other embodiments, in the case if anonymized SUPIs are not used, the UE applies an actual SUCI when registering in the SNPN. The AUSF/UDM in the SNPN can then resolve the UE's actual SUPI from the UE. But since the authentication of the UE relies on the AAA of CH, it is only after the authentication by the AAA of CH and the AAA sends the authenticated UE ID back to the SNPN, then the UDM/AUSF can be certain that it is the real SUPI of the authenticated UE. Hence, also in this case the UE ID in some embodiments is returned from the AAA of CH to the AUSF of SNPN after a successful authentication.

In both cases, the UE ID sent back by the AAA to the AUSF/UDM can be a SUPI if the AAA/CH is trusted to the SNPN or an association ID otherwise. This association ID can be based on a public UE ID, i.e., a GPSI.

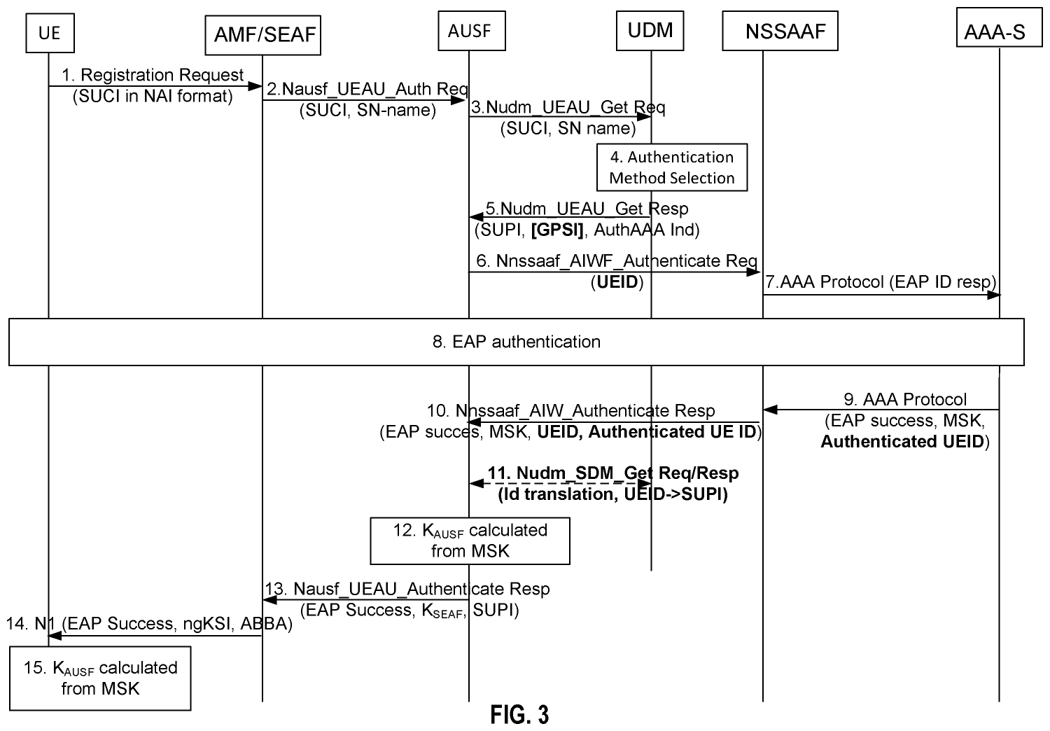

FIG. 3 shows primary authentication with an external domain according to some embodiments.
0. The UE shall be configured with credentials from the Credentials holder, e.g., SUPI containing a network-specific identifier and credentials for any key-generating EAP-method. It is further assumed that there exists a trust relation between the SNPN and the Credentials holder AAA Server. These entities need to be mutually authenticated, and the information transferred on the interface needs to be confidentiality, integrity, and replay protected.
1. The UE shall select the SNPN and initiate UE registration in the SNPN. For construction of the SUCI, methods in clause 6.12 of TS 33.501 v17.2.1 can be used. If the home network public key of the SNPN is not provisioned in the UE, the UE shall create a SUCI using a null scheme with anonymised SUPI as described in Annex B of TS 33.501 v17.2.1.
2. The AMF within the SNPN shall initiate a primary authentication for the UE using a Nausf_UEAuthentication_Authenticate service operation with the AUSF. The AMF shall select an AUSF based on the Home Network Identifier (HNI) of the SUCI (i.e., realm for NSI SUPI type) presented by the UE as specified in TS 23.501 v17.1.1. In this case, “anonymous SUCI” is used in step 1, the realm of the “anonymous SUCI” shall facilitate the selection of the AUSF/UDM in the corresponding SNPN owner of the subscription for the SNPN UE.
3. The AUSF shall initiate a Nudm_UEAuthentication_Get service operation. The AUSF shall select a UDM also using the SUCI/SUPI provided by the AMF as specified in TS 23.501 v17.1.1.
NOTE 1: SUPI will be used instead of SUCI in the case of a re-authentication.
4. In case the UDM receives a SUCI, the UDM shall resolve the SUCI to the SUPI before checking the authentication method applicable for the SUPI. The UDM decides to run primary authentication with an external entity based on subscription data or by looking at the realm part of the SUPI in NAI format. When anonymous SUCI is used, the UDM can still decide based on the realm part of SUPI, perhaps in combination with subscription data, that primary authentication is to be run with an external entity. Alternatively, the AUSF may skip the interaction with the UDM and decide to execute primary authentication based on local configuration of realm part of the SUPI.
5. The UDM shall provide the AUSF with the UE SUPI and shall indicate to the AUSF to run primary authentication with an external Credentials holder. When anonymous SUCI is used, the UDM returns an anonymous SUPI to the AUSF. Depending on the trust relation with the AAA Server, the UDM may provide the user SUPI (if the AAA Server is trusted for the SNPN) and additionally an alternative identifier (e.g., GPSI) suitable to be presented to or communicated with the AAA server.
6. Based on the indication from the UDM, the AUSF shall select an NSSAAF as defined in 3GPP TS 23.501 v17.1.1 and initiate a Nnssaaf_AIWF_Authenticate service operation towards that NSSAAF as defined in section 14.4.x of TS 23.501 v17.1.1. In some embodiments, this step exemplifies the signaling 22 in FIG. 1, e.g., for initiating primary authentication. Depending on the trust relation with the AAA Server, the AUSF includes SUPI or GPSI as UE ID in the message. Note the SUPI can be an anonymous SUPI if it is received from step 5.
7. The NSSAAF shall select AAA Server based on the domain name corresponding to the realm part of the UE ID provided by the UDM to the AUSF in step 5 (e.g., SUPI, anonymous SUPI or alternative ID/GPSI). The NSSAAF shall perform related protocol conversion and relay messages to the AAA Server. Note, the NSSAAF may optionally send the received UE ID in the message (not shown in the flow).
8. The UE and AAA Server shall perform mutual authentication. The AAA Server shall act as the EAP Server for the purpose of primary authentication. When anonymous SUCI/SUPI or an alternative UE ID/GPSI to SUPI is used, the AAA-Server requests an identifier to the UE using an EAP ID Request before executing the EAP authentication method.
9. After successful authentication, the MSK and the authenticated UE ID (SUPI or alternative UEID/GPSI) shall be provided from the AAA Server to the NSSAAF. The AAA server can derive the authenticated UE ID from EAP ID from the authentication, or use EAP ID as authenticated UE ID. Alternatively, if NSSAF has provided UE ID in step 7, the AAA server may check the match of the received UE ID and the authenticated ID and determine the authentication result based on the match result (e.g., whether EAP success should be sent).
10. The NSSAAF returns the MSK and the UE ID received from step 6 and/or the authenticated UE ID received from step 9 (SUPI or alternative UEID/GPSI) to the AUSF using the Nnssaaf_AIWF_Authenticate service operation response message. In some embodiments, this step exemplifies the signaling 24 that the authentication server 14 in FIG. 1 receives, e.g., where the asserted identifier 26 in FIG. 1 is exemplified as the authenticated UE ID.
11. The AUSF checks the match of SUPI received from step 5 with the authenticated UEID/SUPI to determine the authentication result in SNPN. If anonymous SUPI or no SUPI is received from step 5, AUSF shall check the UDM of UE's subscription and authentication profile based on the received authenticated UEID/SUPI. For example, if the authenticated UEID is GPSI, the AUSF will invoke UDM service to translate the GPSI to SUPI using a Nudm_SDM_Get (Identifier translation) service operation.
12. The AUSF shall use the most significant 256 bits of MSK as the K_{AUSF}. The AUSF shall also derive K_{SEAF} from the K_{AUSF} as defined in Annex A.6 of TS 33.501 v17.2.1.
13. The AUSF shall send the successful indication together with the SUPI of the UE to the AMF together with the resulting K_{SEAF}.
14. The AMF shall send the EAP success in a NAS message.
15. The UE shall derive the K_{AUSF} from MSK as described in step 12.

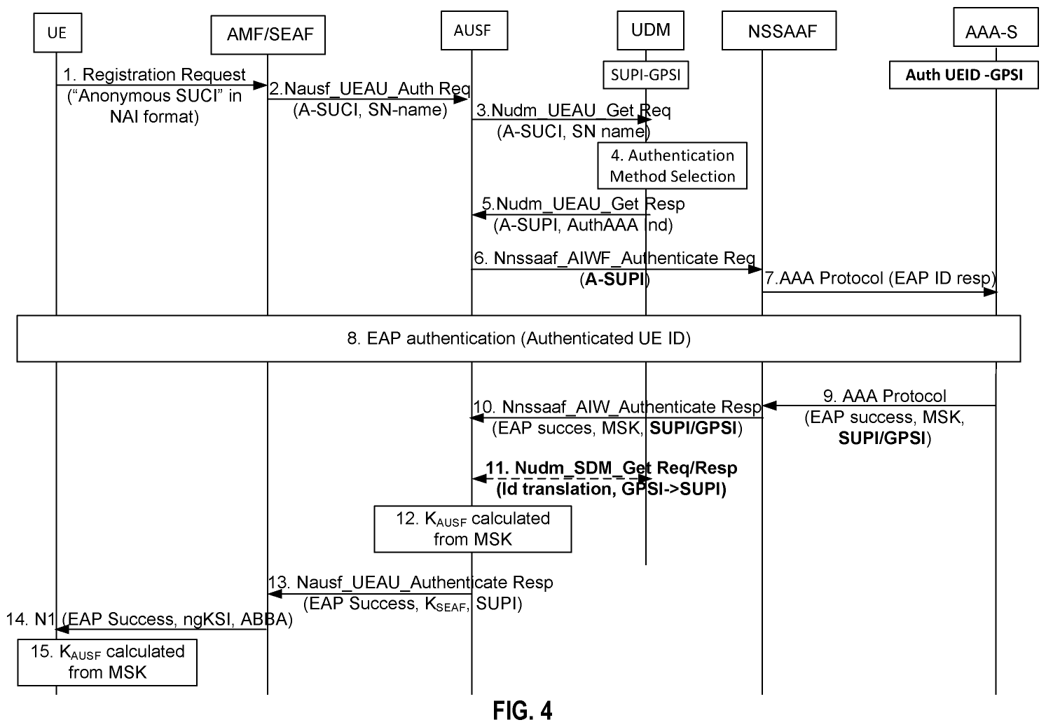

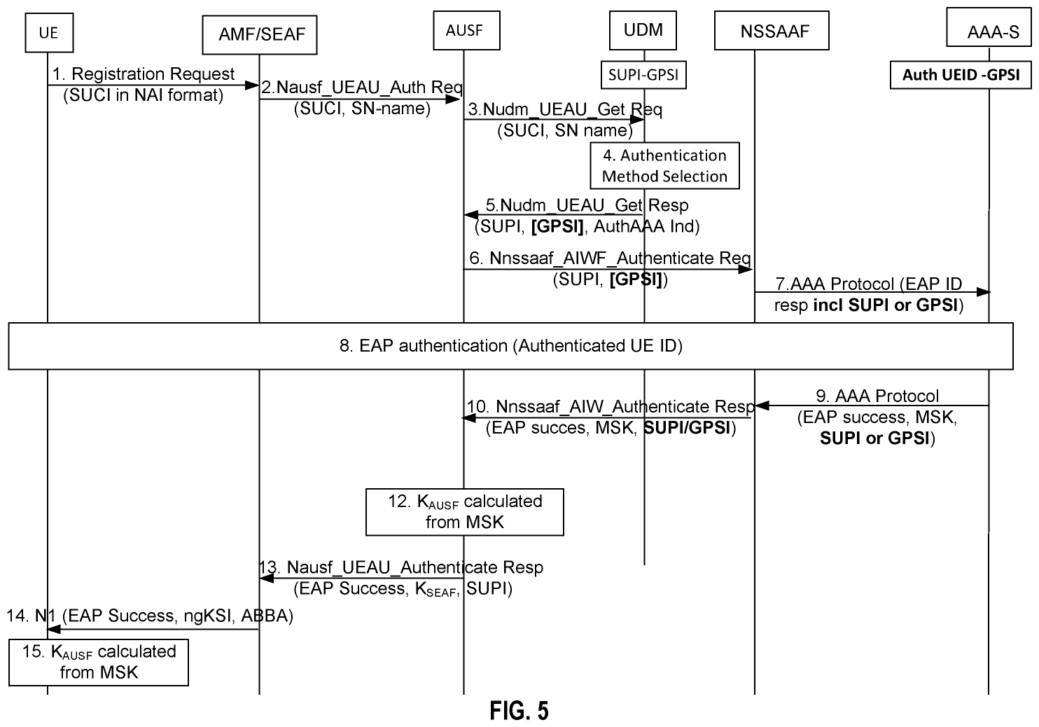

FIGS. 4 and 5 illustrate the different cases depending on the type of SUCI provided by the UE. Steps of FIGS. 4 and 5 are the same as described above with respect to FIG. 3, except where noted below.

GPSI is used when the AAA-S is not trusted. Otherwise, SUPI can be shared between the AUSF and the AAA-S.

FIG. 4 in particular shows primary authentication with an external domain when an anonymous SUCI is used. In comparison to FIG. 3, then, the UE provides an anonymous SUCI (A-SUCI) in NAI format in the Registration Request (Step 1) to the AMF, which is propagated to the AUSF and the UDM. The UDM correspondingly returns an anonymous SUPI (A-SUPI) to the AUSF in Step 5 corresponding to the A-SUCI. Here, since the AAA-S is trusted, no GPSI is used.

With the A-SUPI received from the UDM, the AUSF sends the A-SUPI to the NSSAAF in its authentication request (Step 6). The AAA-S authenticates the UE and returns the SUPI or GPSI as the authenticated UE ID (Step 9), which is relayed to the AUSF (Step 10). If a GPSI is returned, the AUSF translates the GPSI to the UE's SUPI with UDM assistance. Operation then proceeds as described in FIG. 3.

FIG. 5 shows primary authentication with an external domain when a non-anonymous SUCI is used. In this example, the UDM returns a GPSI to the AUSF (Step 5) corresponding to the non-anonymous SUCI provided by the UE in Step 1. The UDM also returns the non-anonymous SUPI corresponding to the non-anonymous SUCI.

In one embodiment, the AUSF correspondingly provides the GPSI to the NSSAAF in its authentication request (Step 6), e.g., in case the AAA-S is not trusted. In this case, the GPSI is relayed to the AAA-S. The AAA-S may then return a GPSI based on which the UE is authenticated (Step 9). Since the AUSF already understands the relationship between the GPSI and the SUPI from Step 5, the AUSF need not employ the assistance of the UDM to translate the returned GPSI to a SUPI. Accordingly, operation may proceed as described above in FIG. 3.

In another embodiment, by contrast, the AUSF provides the SUPI to the NSSAAF in its authentication request (Step 6), e.g., in case the AAA-S is trusted. In this case, the SUPI is relayed to the AAA-S. The AAA-S may then return a SUPI based on which the UE is authenticated (Step 9), at which point operation may proceed as described above in FIG. 3.

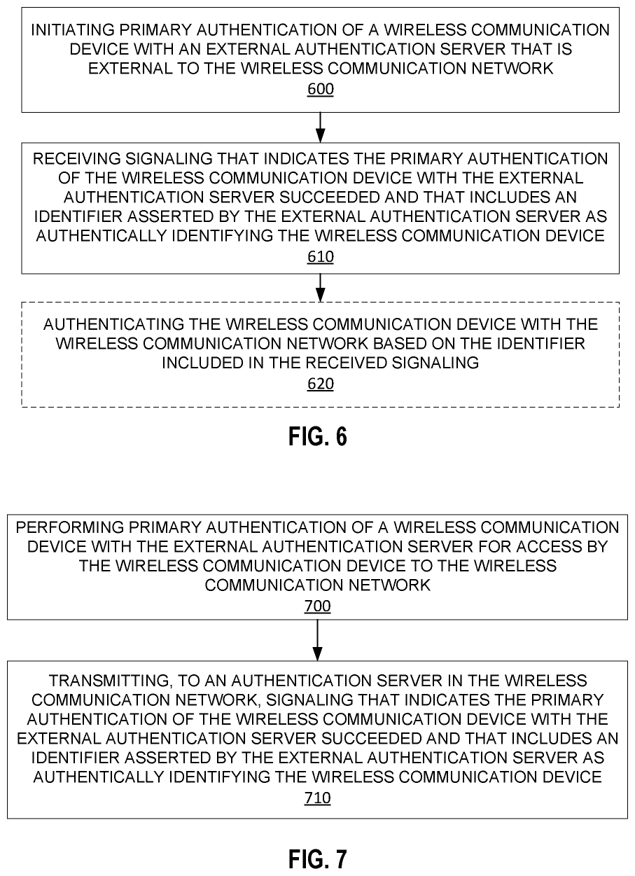

In view of the above modifications and variations, FIG. 6 depicts a method performed by an authentication server 14 in a wireless communication network 10 in accordance with particular embodiments. The method includes initiating primary authentication of a wireless communication device 12 with an external authentication server 20 that is external to the wireless communication network 10 (Block 600). The method also comprises receiving signaling 24 that indicates the primary authentication of the wireless communication device 12 with the external authentication server 20 succeeded and that includes an identifier 26 asserted by the external authentication server 20 as authentically identifying the wireless communication device 12 (Block 610). The identifier 26 may for example be, or be associated with, an authenticated identifier based on which the external authentication server 20 authenticated the wireless communication device 12 via the primary authentication. Regardless, the method in some embodiments also comprises authenticating the wireless communication device 12 with the wireless communication network 10 based on the identifier 26 included in the received signaling 24 (Block 620).

Additional aspects of the method in FIG. 6 are enumerated in GROUP A EMBODIMENTS herein.

For example, in some embodiments, said initiating comprises initiating primary authentication of the wireless communication device with the external authentication server using an anonymous identifier that does not identify the wireless communication device. In one example, the anonymous identifier is an anonymous Subscription Permanent Identifier, SUPI.

In some embodiments, the identifier included in the received signaling is a non-anonymous identifier. For example, in one embodiment, the non-anonymous identifier is a non-anonymous SUPI.

In some embodiments, the identifier included in the received signaling is a public identifier that identifies the wireless communication device to an external network external to the wireless communication network. For example, in one embodiment, the public identifier is a Generic Public Subscription Identifier, GPSI. Alternatively or additionally, in some embodiments, the method further comprises translating, or requesting translation of, the public identifier to an identifier that identifies the wireless communication device to the wireless communication network.

In some embodiments, the identifier included in the received signaling is, or is associated with, an authenticated identifier based on which the external authentication server authenticated the wireless communication device via the primary authentication. For example, in one embodiment, the authenticated identifier is an Extensible Authentication Protocol, EAP, Identity.

In some embodiments, said initiating comprises initiating primary authentication of the wireless communication device with the external authentication server using a presented identifier that the wireless communication device has presented as identifying the wireless communication device to the wireless communication network. In one such embodiment, authenticating the wireless communication device with the wireless communication network based on the identifier included in the received signaling comprises confirming that the presented identifier corresponds to the identifier included in the received signaling.

In some embodiments, the primary authentication is initiated as part of a procedure for registering the wireless communication device with the wireless communication network. In one such embodiment, the method further comprises registering the wireless communication device with the wireless communication network based on successful authentication of the wireless communication device with the wireless communication network. For example, where successful authentication of the wireless communication device with the wireless communication network is a pre-requisite for registration of the wireless communication device with the wireless communication network, the procedure for registering the wireless communication device with the wireless communication network may indeed result in registration of the wireless communication device, provided that any other requirements for registration (e.g., authorization) are met. On the other hand, if authentication of the wireless communication device with the wireless communication network fails, the procedure for registering the wireless communication device with the wireless communication network likewise fails.

In some embodiments, the wireless communication network is a standalone non-public network.

In some embodiments, the authentication server implements an Authentication Server Function, AUSF.

FIG. 7 depicts a method performed by an external authentication server 20 external to a wireless communication network 10 in accordance with other particular embodiments. The method includes performing primary authentication of a wireless communication device 12 with the external authentication server 20 for access by the wireless communication device 12 to the wireless communication network 10 (Block 700). The method also comprises transmitting, to an authentication server 14 in the wireless communication network 10, signaling 24 that indicates the primary authentication of the wireless communication device 12 with the external authentication server 20 succeeded and that includes an identifier 26 asserted by the external authentication server 20 as authentically identifying the wireless communication device 12 (Block 710).

Additional aspects of the method in FIG. 7 are enumerated in GROUP B EMBODIMENTS herein.

In some embodiments, the method further comprises receiving signaling that triggers the external authentication server to perform the primary authentication of the wireless communication device with the external authentication server, wherein the signaling includes an anonymous identifier for the wireless communication device. In one embodiment, the anonymous identifier is an anonymous Subscription Permanent Identifier, SUPI.

In some embodiments, the identifier included in the transmitted signaling is a non-anonymous identifier. For example, the non-anonymous identifier is a non-anonymous SUPI.

In some embodiments, the identifier included in the transmitted signaling is a public identifier that identifies the wireless communication device to an external network external to the wireless communication network. For example, the public identifier is a Generic Public

In some embodiments, the identifier included in the transmitted signaling is, or is associated with, an authenticated identifier based on which the external authentication server authenticated the wireless communication device via the primary authentication. For example, the authenticated identifier is an Extensible Authentication Protocol, EAP, Identity.

In some embodiments, the wireless communication network is a standalone non-public network.

In some embodiments, the authentication server implements an Authentication Server Function, AUSF.

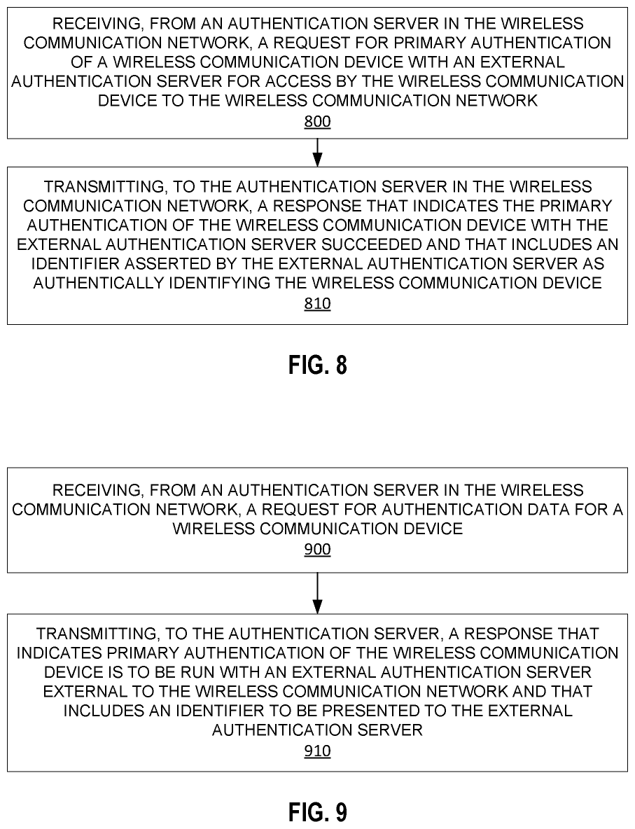

FIG. 8 depicts a method performed by a network node 16 (e.g., implementing an NSSAAF) in a wireless communication network 10 in accordance with other particular embodiments. The method includes receiving, from an authentication server 14 in the wireless communication network 10, a request for primary authentication of a wireless communication device 12 with an external authentication server 20 for access by the wireless communication device 12 to the wireless communication network 10 (Block 800). The method also comprises transmitting, to the authentication server 13 in the wireless communication network 10, a response that indicates the primary authentication of the wireless communication device 12 with the external authentication server 20 succeeded and that includes an identifier 26 asserted by the external authentication server 20 as authentically identifying the wireless communication device 12 (Block 810).

Additional aspects of the method in FIG. 8 are enumerated in GROUP C EMBODIMENTS herein.

For example, in some embodiments, the request includes an anonymous identifier for the wireless communication device. For instance, the anonymous identifier is an anonymous Subscription Permanent Identifier, SUPI.

In some embodiments, the identifier included in the transmitted signaling is a non-anonymous identifier. For example, the non-anonymous identifier is a non-anonymous SUPI.

In some embodiments, the identifier included in the transmitted signaling is a public identifier that identifies the wireless communication device to an external network external to the wireless communication network. For example, the public identifier is a Generic Public Subscription Identifier, GPSI. In some embodiments,

In some embodiments, the identifier included in the transmitted signaling is, or is associated with, an authenticated identifier based on which the external authentication server authenticated the wireless communication device via the primary authentication. For example, the authenticated identifier is an Extensible Authentication Protocol, EAP, Identity.

In some embodiments, the wireless communication network is a standalone non-public network.

In some embodiments, the authentication server implements an Authentication Server Function, AUSF.

In some embodiments, the network node implements a Network Slice-Specific Authentication and Authorization Function, NSSAAF.

FIG. 9 depicts a method performed by a network node (e.g., implementing a UDM) in a wireless communication network in accordance with other particular embodiments. The method includes receiving, from an authentication server in the wireless communication network, a request for authentication data for a wireless communication device (Block 900). The method also comprises transmitting, to the authentication server, a response that indicates primary authentication of the wireless communication device is to be run with an external authentication server external to the wireless communication network and that includes an identifier to be presented to the external authentication server (Block 910).

Additional aspects of the method in FIG. 9 are enumerated in GROUP D EMBODIMENTS herein.

For example, in some embodiments, the identifier included in the response is an anonymous identifier for the wireless communication device. In some embodiments, the anonymous identifier is an anonymous Subscription Permanent Identifier, SUPI.

In some embodiments, the identifier included in the response is a public identifier that identifies the wireless communication device to an external network external to the wireless communication network. In one example, the public identifier is a Generic Public Subscription Identifier, GPSI.

In some embodiments, the request includes an anonymous identifier for the wireless communication device. In one such embodiment, the method further comprises deciding, based on a realm part of the anonymous identifier, that primary authentication of the wireless communication device is to be run with the external authentication server external to the wireless communication network.

In some embodiments, the wireless communication network is a standalone non-public network.

In some embodiments, the authentication server implements an Authentication Server Function, AUSF.

Embodiments herein also include a method performed by a network node in a wireless communication network. The method comprises receiving a request to translate a public identifier, which identifies the wireless communication device to an external network external to the wireless communication network, to a non-public identifier which identifies the wireless communication device to the wireless communication network. The method also comprises translating the public identifier to the non-public identifier, and transmitting a response that includes the non-public identifier.

In some embodiments, the public identifier is a Generic Public Subscription Identifier, GPSI.

In some embodiments, the non-public identifier is a Subscription Permanent Identifier, SUPI.

In some embodiments, the wireless communication network is a standalone non-public network.

In some embodiments, the request is received from an authentication server. In some embodiments, the authentication server implements an Authentication Server Function, AUSF.

Embodiments herein also include corresponding apparatuses. Embodiments herein for instance include an authentication server 14 configured to perform any of the steps of any of the embodiments described above for the authentication server 14.

Embodiments also include an authentication server 14 comprising processing circuitry and power supply circuitry. The processing circuitry is configured to perform any of the steps of any of the embodiments described above for the authentication server 14. The power supply circuitry is configured to supply power to the authentication server 14.

Embodiments further include an authentication server 14 comprising processing circuitry. The processing circuitry is configured to perform any of the steps of any of the embodiments described above for the authentication server 14. In some embodiments, the authentication server 14 further comprises communication circuitry.

Embodiments further include an authentication server 14 comprising processing circuitry and memory. The memory contains instructions executable by the processing circuitry whereby the authentication server 14 is configured to perform any of the steps of any of the embodiments described above for the authentication server 14.

Embodiments also include an external authentication server 20 comprising processing circuitry and power supply circuitry. The processing circuitry is configured to perform any of the steps of any of the embodiments described above for the external authentication server 20. The power supply circuitry is configured to supply power to the external authentication server 20.

Embodiments further include an external authentication server 20 comprising processing circuitry. The processing circuitry is configured to perform any of the steps of any of the embodiments described above for the external authentication server 20. In some embodiments, the external authentication server 20 further comprises communication circuitry.

Embodiments further include an external authentication server 20 comprising processing circuitry and memory. The memory contains instructions executable by the processing circuitry whereby the external authentication server 20 is configured to perform any of the steps of any of the embodiments described above for the external authentication server 20.

Embodiments herein also include a network node 16 configured to perform any of the steps of any of the embodiments described above for the network node 16.

Embodiments also include a network node 16 comprising processing circuitry and power supply circuitry. The processing circuitry is configured to perform any of the steps of any of the embodiments described above for the network node 16. The power supply circuitry is configured to supply power to the network node 16.

Embodiments further include a network node 16 comprising processing circuitry. The processing circuitry is configured to perform any of the steps of any of the embodiments described above for the network node 16. In some embodiments, the network node 16 further comprises communication circuitry.

Embodiments further include a network node 16 comprising processing circuitry and memory. The memory contains instructions executable by the processing circuitry whereby the network node 16 is configured to perform any of the steps of any of the embodiments described above for the network node 16.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

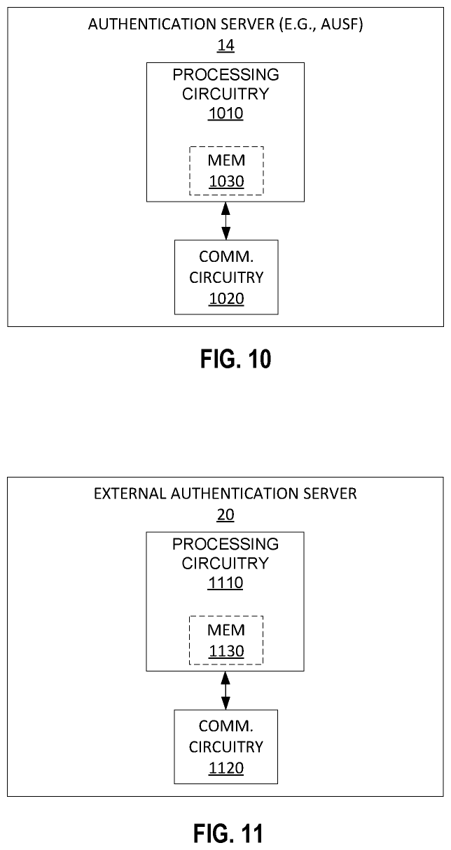

FIG. 10 for example illustrates an authentication server 14 as implemented in accordance with one or more embodiments. As shown, the authentication server 14 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., in FIG. 6, such as by executing instructions stored in memory 1030. The processing circuitry 1010 in this regard may implement certain functional means, units, or modules.

FIG. 11 illustrates an external authentication server 20 as implemented in accordance with one or more embodiments. As shown, the external authentication server 20 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above, e.g., in FIG. 7, such as by executing instructions stored in memory 1130. The processing circuitry 1110 in this regard may implement certain functional means, units, or modules.

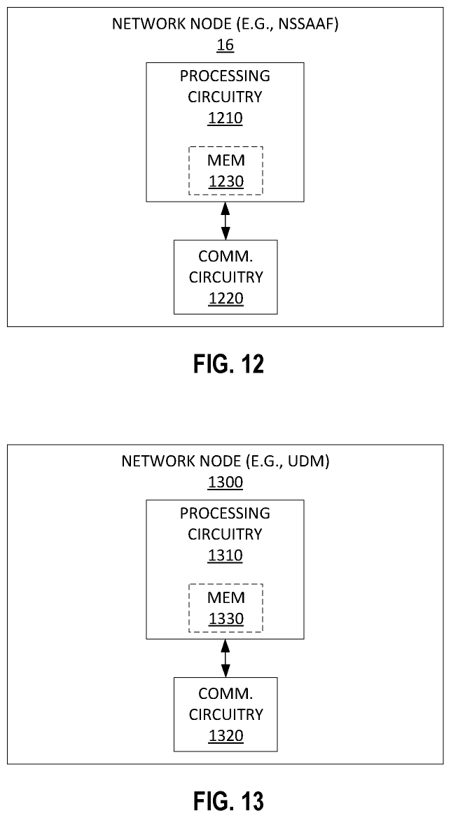

FIG. 12 illustrates a network node 16 as implemented in accordance with one or more embodiments. The network node 16 may for example implement an NSSAAF. As shown, the network node 16 includes processing circuitry 1210 and communication circuitry 1220. The communication circuitry 1220 is configured to transmit and/or receive information to and/or from one or more other nodes, e.g., via any communication technology. The processing circuitry 1210 is configured to perform processing described above, e.g., in FIG. 8, such as by executing instructions stored in memory 1230. The processing circuitry 1210 in this regard may implement certain functional means, units, or modules.

FIG. 13 illustrates a network node 1300 as implemented in accordance with one or more embodiments. The network node 1300 may for example implement a UDM. As shown, the network node 1300 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 9, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

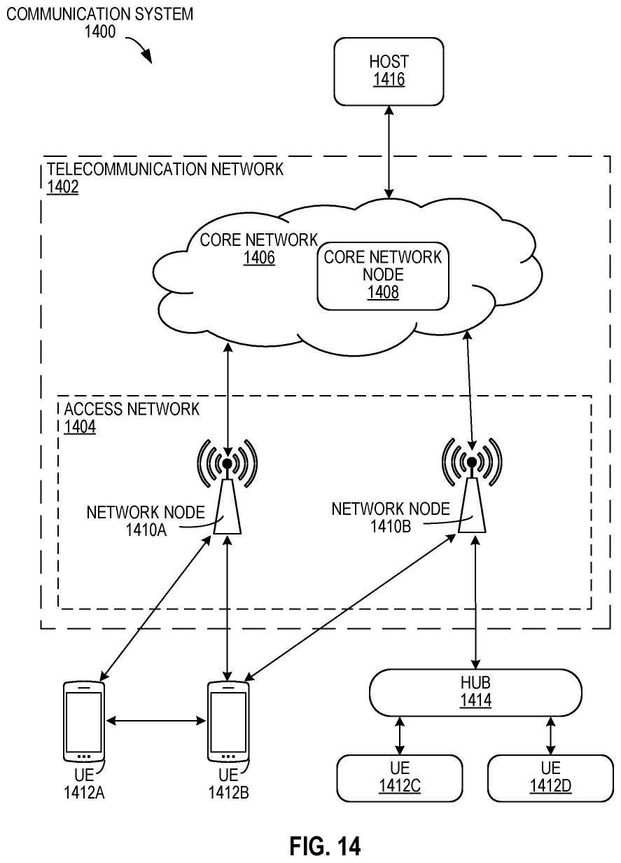

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3rd Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

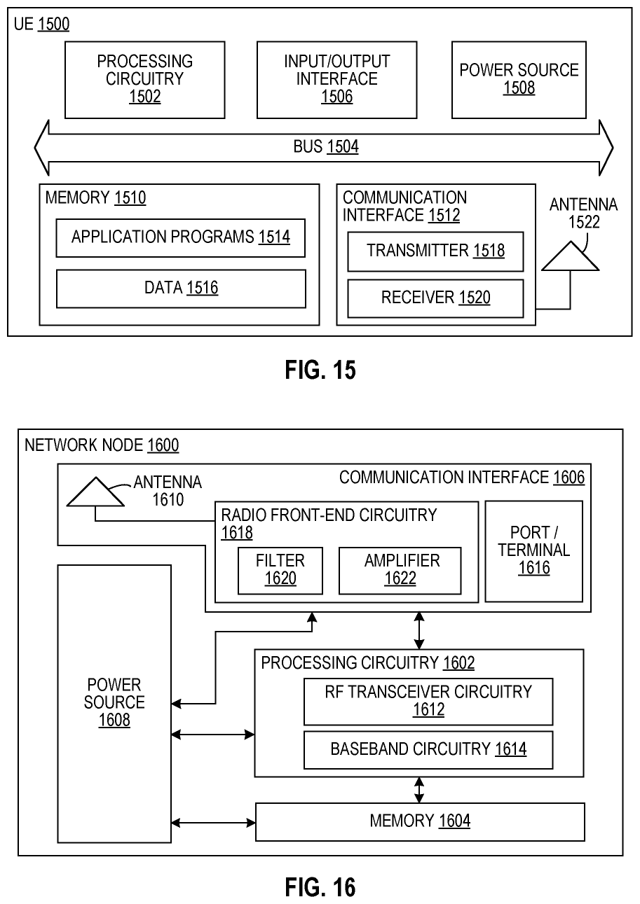

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

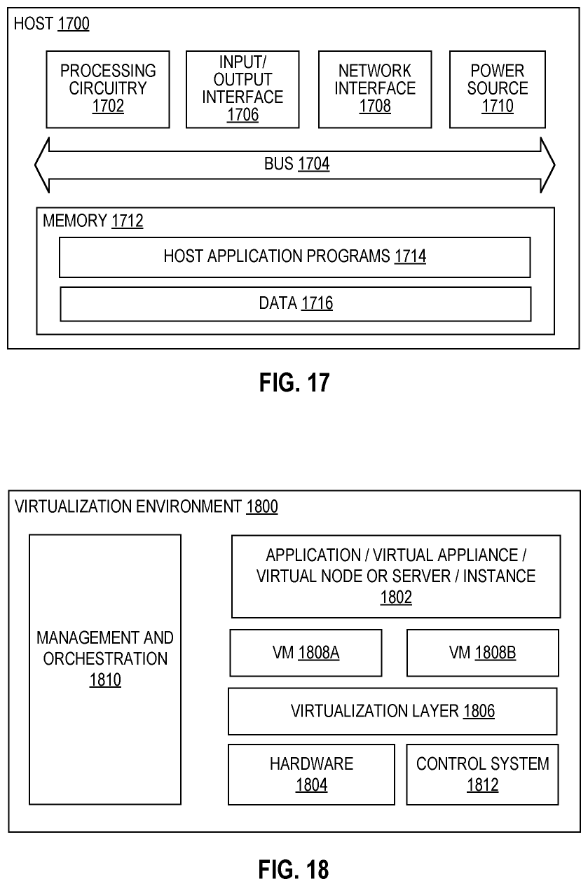

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by an authentication server in a wireless communication network, the method comprising:
initiating primary authentication of a wireless communication device with an external authentication server that is external to the wireless communication network;
receiving signaling that indicates the primary authentication of the wireless communication device with the external authentication server succeeded and that includes an identifier asserted by the external authentication server as authentically identifying the wireless communication device; and
authenticating the wireless communication device with the wireless communication network based on the identifier included in the received signaling.

A2. The method of embodiment A1, wherein said initiating comprises initiating primary authentication of the wireless communication device with the external authentication server using an anonymous identifier that does not identify the wireless communication device.

A3. The method of embodiment A2, wherein the anonymous identifier is an anonymous Subscription Permanent Identifier, SUPI.

A4. The method of any of embodiments A1-A3, wherein the identifier included in the received signaling is a non-anonymous identifier.

A5. The method of embodiment A4, wherein the non-anonymous identifier is a non-anonymous SUPI.

A6. The method of any of embodiments A1-A4, wherein the identifier included in the received signaling is a public identifier that identifies the wireless communication device to an external network external to the wireless communication network.

A7. The method of embodiment A6, wherein the public identifier is a Generic Public Subscription Identifier, GPSI.

A8. The method of any of embodiments A6-A7, further comprising translating, or requesting translation of, the public identifier to an identifier that identifies the wireless communication device to the wireless communication network.

A9. The method of any of embodiments A1-A8, wherein the identifier included in the received signaling is, or is associated with, an authenticated identifier based on which the external authentication server authenticated the wireless communication device via the primary authentication.

A10. The method of embodiment A9, wherein the authenticated identifier is an Extensible Authentication Protocol, EAP, Identity.

A11. The method of any of embodiments A1-A10, wherein said initiating comprises initiating primary authentication of the wireless communication device with the external authentication server using a presented identifier that the wireless communication device has presented as identifying the wireless communication device to the wireless communication network, and wherein authenticating the wireless communication device with the wireless communication network based on the identifier included in the received signaling comprises confirming that the presented identifier corresponds to the identifier included in the received signaling.

A12. The method of any of embodiments A1-A11, wherein the primary authentication is initiated as part of a procedure for registering the wireless communication device with the wireless communication network, and wherein the method further comprises registering the wireless communication device with the wireless communication network based on successful authentication of the wireless communication device with the wireless communication network.

A13. The method of any of embodiments A1-A12, wherein the wireless communication network is a standalone non-public network.

A14. The method of any of embodiments A1-A13, wherein the authentication server implements an Authentication Server Function, AUSF.

### Group B Embodiments

B1. A method performed by an external authentication server external to a wireless communication network, the method comprising:
performing primary authentication of a wireless communication device with the external authentication server for access by the wireless communication device to the wireless communication network; and
transmitting, to an authentication server in the wireless communication network, signaling that indicates the primary authentication of the wireless communication device with the external authentication server succeeded and that includes an identifier asserted by the external authentication server as authentically identifying the wireless communication device.

B2. The method of embodiment B1, further comprising receiving signaling that triggers the external authentication server to perform the primary authentication of the wireless communication device with the external authentication server, wherein the signaling includes an anonymous identifier for the wireless communication device.

B3. The method of embodiment B2, wherein the anonymous identifier is an anonymous Subscription Permanent Identifier, SUPI.

B4. The method of any of embodiments B1-B3, wherein the identifier included in the transmitted signaling is a non-anonymous identifier.

B5. The method of embodiment B4, wherein the non-anonymous identifier is a non-anonymous SUPI.

B6. The method of any of embodiments B1-B4, wherein the identifier included in the transmitted signaling is a public identifier that identifies the wireless communication device to an external network external to the wireless communication network.

B7. The method of embodiment B6, wherein the public identifier is a Generic Public Subscription Identifier, GPSI.

B8. The method of any of embodiments B1-B7, wherein the identifier included in the transmitted signaling is, or is associated with, an authenticated identifier based on which the external authentication server authenticated the wireless communication device via the primary authentication.

B9. The method of embodiment B8, wherein the authenticated identifier is an Extensible Authentication Protocol, EAP, Identity.

B10. The method of any of embodiments B1-B9, wherein the wireless communication network is a standalone non-public network.

B11. The method of any of embodiments B1-B10, wherein the authentication server implements an Authentication Server Function, AUSF.

### Group C Embodiments

C1. A method performed by a network node in a wireless communication network, the method comprising:
receiving, from an authentication server in the wireless communication network, a request for primary authentication of a wireless communication device with an external authentication server for access by the wireless communication device to the wireless communication network; and
transmitting, to the authentication server in the wireless communication network, a response that indicates the primary authentication of the wireless communication device with the external authentication server succeeded and that includes an identifier asserted by the external authentication server as authentically identifying the wireless communication device.

C2. The method of embodiment C1, wherein the request includes an anonymous identifier for the wireless communication device.

C3. The method of embodiment C2, wherein the anonymous identifier is an anonymous Subscription Permanent Identifier, SUPI.

C4. The method of any of embodiments C1-C3, wherein the identifier included in the transmitted signaling is a non-anonymous identifier.

C5. The method of embodiment C4, wherein the non-anonymous identifier is a non-anonymous SUPI.

C6. The method of any of embodiments C1-C4, wherein the identifier included in the transmitted signaling is a public identifier that identifies the wireless communication device to an external network external to the wireless communication network.

C7. The method of embodiment C6, wherein the public identifier is a Generic Public Subscription Identifier, GPSI.

C8. The method of any of embodiments C1-C7, wherein the identifier included in the transmitted signaling is, or is associated with, an authenticated identifier based on which the external authentication server authenticated the wireless communication device via the primary authentication.

C9. The method of embodiment C8, wherein the authenticated identifier is an Extensible Authentication Protocol, EAP, Identity.

C10. The method of any of embodiments C1-C9, wherein the wireless communication network is a standalone non-public network.

C11. The method of any of embodiments C1-C10, wherein the authentication server implements an Authentication Server Function, AUSF.

C12. The method of any of embodiments C1-C11, wherein the network node implements a Network Slice-Specific Authentication and Authorization Function, NSSAAF.

### Group D Embodiments

D1. A method performed by a network node in a wireless communication network, the method comprising:
receiving, from an authentication server in the wireless communication network, a request for authentication data for a wireless communication device; and
transmitting, to the authentication server, a response that indicates primary authentication of the wireless communication device is to be run with an external authentication server external to the wireless communication network and that includes an identifier to be presented to the external authentication server.

D2. The method of embodiment D1, wherein the identifier included in the response is an anonymous identifier for the wireless communication device.

D3. The method of embodiment D2, wherein the anonymous identifier is an anonymous Subscription Permanent Identifier, SUPI.

D4. The method of any of embodiments D1-D3, wherein the identifier included in the response is a public identifier that identifies the wireless communication device to an external network external to the wireless communication network.

D5. The method of embodiment D4, wherein the public identifier is a Generic Public Subscription Identifier, GPSI.

D6. The method of any of embodiments D1-D5, wherein the request includes an anonymous identifier for the wireless communication device.

D7. The method of embodiment D6, further comprising deciding, based on a realm part of the anonymous identifier, that primary authentication of the wireless communication device is to be run with the external authentication server external to the wireless communication network.

D8. The method of any of embodiments D1-D7, wherein the wireless communication network is a standalone non-public network.

D9. The method of any of embodiments D1-D8, wherein the authentication server implements an Authentication Server Function, AUSF.

DD1. A method performed by a network node in a wireless communication network, the method comprising:
receiving a request to translate a public identifier, which identifies the wireless communication device to an external network external to the wireless communication network, to a non-public identifier which identifies the wireless communication device to the wireless communication network;
translating the public identifier to the non-public identifier; and
transmitting a response that includes the non-public identifier.

DD2. The method of embodiment DD2, wherein the public identifier is a Generic Public Subscription Identifier, GPSI.

DD3. The method of any of embodiments DD1-DDD2, wherein the non-public identifier is a Subscription Permanent Identifier, SUPI.

DD4. The method of any of embodiments DD1-DD2, wherein the wireless communication network is a standalone non-public network.

DD5. The method of any of embodiments DD1-DD4, wherein request is received from an authentication server.

DD6. The method of embodiment DD5, wherein the authentication server implements an Authentication Server Function, AUSF.

### Group E Embodiments

E1. An authentication server configured to perform any of the steps of any of the Group A embodiments.

E2. An authentication server comprising processing circuitry configured to perform any of the steps of any of the Group A embodiments.

E3. An authentication server comprising:
communication circuitry; and
processing circuitry configured to perform any of the steps of any of the Group A embodiments.

E4. An authentication server comprising:
processing circuitry configured to perform any of the steps of any of the Group A embodiments;
power supply circuitry configured to supply power to the authentication server.

E5. An authentication server comprising:
processing circuitry and memory, the memory containing instructions executable by the processing circuitry whereby the authentication server is configured to perform any of the steps of any of the Group A embodiments.

E6. A computer program comprising instructions which, when executed by at least one processor of an authentication server, causes the authentication server to carry out the steps of any of the Group A embodiments.

E7. A carrier containing the computer program of embodiment E6, wherein the carrier is one of an electronic signal, optical signal, radio signal, or computer readable storage medium.

E8. An external authentication server configured to perform any of the steps of any of the Group B embodiments.

E9. An external authentication server comprising processing circuitry configured to perform any of the steps of any of the Group B embodiments.

E10. An external authentication server comprising:
communication circuitry; and
processing circuitry configured to perform any of the steps of any of the Group B embodiments.

E11. An external authentication server comprising:
processing circuitry configured to perform any of the steps of any of the Group B embodiments;
power supply circuitry configured to supply power to the external authentication server.

E12. An external authentication server comprising:
processing circuitry and memory, the memory containing instructions executable by the processing circuitry whereby the external authentication server is configured to perform any of the steps of any of the Group B embodiments.

E13. A computer program comprising instructions which, when executed by at least one processor of an external authentication server, causes the external authentication server to carry out the steps of any of the Group B embodiments.

E14. A carrier containing the computer program of embodiment E13, wherein the carrier is one of an electronic signal, optical signal, radio signal, or computer readable storage medium.

E15. A network node configured to perform any of the steps of any of the Group C or Group D embodiments.

E16. A network node comprising processing circuitry configured to perform any of the steps of any of the Group C or Group D embodiments.

E17. A network node comprising:
communication circuitry; and
processing circuitry configured to perform any of the steps of any of the Group C or Group D embodiments.

E18. A network node comprising:
processing circuitry configured to perform any of the steps of any of the Group C or Group D embodiments;
power supply circuitry configured to supply power to the network node.

E19. A network node comprising:
processing circuitry and memory, the memory containing instructions executable by the processing circuitry whereby the network node is configured to perform any of the steps of any of the Group C or Group D embodiments.

E20. A computer program comprising instructions which, when executed by at least one processor of a network node, causes the network node to carry out the steps of any of the Group C or Group D embodiments.

E21. A carrier containing the computer program of embodiment E20, wherein the carrier is one of an electronic signal, optical signal, radio signal, or computer readable storage medium.

1. A method performed by an authentication server in a wireless communication network, the method comprising:
initiating primary authentication of a wireless communication device with an external authentication server that is external to the wireless communication network;
receiving signaling that indicates the primary authentication of the wireless communication device with the external authentication server succeeded and that includes an identifier asserted by the external authentication server as authentically identifying the wireless communication device; and
authenticating the wireless communication device with the wireless communication network based on the identifier included in the received signaling.

2. The method of claim 1, wherein said initiating comprises initiating primary authentication of the wireless communication device with the external authentication server using an anonymous identifier that does not identify the wireless communication device, and wherein the identifier included in the received signaling is a non-anonymous identifier.

3. The method of claim 2, wherein the anonymous identifier is an anonymous Subscription Permanent Identifier, SUPI, and wherein the non-anonymous identifier is a non-anonymous SUPI.

4. The method of claim 1, wherein said initiating comprises initiating primary authentication of the wireless communication device with the external authentication server using a presented identifier that the wireless communication device has presented as identifying the wireless communication device to the wireless communication network, and wherein authenticating the wireless communication device with the wireless communication network based on the identifier included in the received signaling comprises confirming that the presented identifier corresponds to the identifier included in the received signaling.

5. The method of claim 4, wherein said confirming comprises transmitting the presented identifier to network equipment implementing a Unified Data Management, UDM, function, and performing said confirming based on a response received from the network equipment implementing the UDM function.

6. The method of claim 1, wherein the primary authentication is initiated as part of a procedure for registering the wireless communication device with the wireless communication network, and wherein the method further comprises registering the wireless communication device with the wireless communication network based on successful authentication of the wireless communication device with the wireless communication network.

7. The method of claim 1, wherein the wireless communication network is a standalone non-public network.

8. A method performed by an external authentication server external to a wireless communication network, the method comprising:
performing primary authentication of a wireless communication device with the external authentication server for access by the wireless communication device to the wireless communication network; and
transmitting, to an authentication server in the wireless communication network, signaling that indicates the primary authentication of the wireless communication device with the external authentication server succeeded and that includes an identifier asserted by the external authentication server as authentically identifying the wireless communication device.

9. The method of claim 8, further comprising receiving signaling that triggers the external authentication server to perform the primary authentication of the wireless communication device with the external authentication server, wherein the signaling includes an anonymous identifier for the wireless communication device.

10. The method of claim 9, wherein the anonymous identifier is an anonymous Subscription Permanent Identifier, SUPI.

11. The method of claim 8, wherein the identifier included in the transmitted signaling is a non-anonymous identifier.

12. The method of claim 11, wherein the non-anonymous identifier is a non-anonymous SUPI.

13. The method of claim 8, wherein the wireless communication network is a standalone non-public network.

14. A method performed by a network node in a wireless communication network, the method comprising:
receiving, from an authentication server in the wireless communication network, a request for primary authentication of a wireless communication device with an external authentication server for access by the wireless communication device to the wireless communication network; and
transmitting, to the authentication server in the wireless communication network, a response that indicates the primary authentication of the wireless communication device with the external authentication server succeeded and that includes an identifier asserted by the external authentication server as authentically identifying the wireless communication device.

15. The method of claim 14, wherein the request includes an anonymous identifier for the wireless communication device, and wherein the identifier included in the transmitted signaling is a non-anonymous identifier.

16. The method of claim 15, wherein the anonymous identifier is an anonymous Subscription Permanent Identifier, SUPI, and wherein the non-anonymous identifier is a non-anonymous SUPI.

17. The method of claim 14, wherein the wireless communication network is a standalone non-public network.

18. The method of claim 14, wherein the authentication server implements an Authentication Server Function, AUSF, and wherein the network node implements a Network Slice-Specific Authentication and Authorization Function, NSSAAF.

19. A method performed by a network node in a wireless communication network, the method comprising:
receiving, from an authentication server in the wireless communication network, a request for authentication data for a wireless communication device; and
transmitting, to the authentication server, a response that indicates primary authentication of the wireless communication device is to be run with an external authentication server external to the wireless communication network and that includes an identifier to be presented to the external authentication server.

20. The method of claim 19, wherein the request includes an anonymous identifier for the wireless communication device, and wherein the identifier included in the response is the anonymous identifier for the wireless communication device.

21. The method of claim 20, wherein the anonymous identifier is an anonymous Subscription Permanent Identifier, SUPI.

22. The method of claim 20, further comprising deciding, based on a realm part of the anonymous identifier, that primary authentication of the wireless communication device is to be run with the external authentication server external to the wireless communication network.

23. The method of claim 19, wherein the wireless communication network is a standalone non-public network.

24. An authentication server configured for use in a wireless communication network, the authentication server comprising:
communication circuitry; and
processing circuitry configured to:
initiate primary authentication of a wireless communication device with an external authentication server that is external to the wireless communication network;
receive signaling that indicates the primary authentication of the wireless communication device with the external authentication server succeeded and that includes an identifier asserted by the external authentication server as authentically identifying the wireless communication device; and
authenticate the wireless communication device with the wireless communication network based on the identifier included in the received signaling.

25. (canceled)

26. An external authentication server external to a wireless communication network, the external authentication server comprising:
communication circuitry; and
processing circuitry configured to:
perform primary authentication of a wireless communication device with the external authentication server for access by the wireless communication device to the wireless communication network; and
transmit, to an authentication server in the wireless communication network, signaling that indicates the primary authentication of the wireless communication device with the external authentication server succeeded and that includes an identifier asserted by the external authentication server as authentically identifying the wireless communication device.

27. (canceled)

28. A network node configured for use in a wireless communication network, the network node comprising:
communication circuitry; and
processing circuitry configured to:
receive, from an authentication server in the wireless communication network, a request for primary authentication of a wireless communication device with an external authentication server for access by the wireless communication device to the wireless communication network; and
transmit, to the authentication server in the wireless communication network, a response that indicates the primary authentication of the wireless communication device with the external authentication server succeeded and that includes an identifier asserted by the external authentication server as authentically identifying the wireless communication device.

29. (canceled)

30. A network node configured for use in a wireless communication network, the network node comprising:
communication circuitry; and
processing circuitry configured to:
receive, from an authentication server in the wireless communication network, a request for authentication data for a wireless communication device; and
transmit, to the authentication server, a response that indicates primary authentication of the wireless communication device is to be run with an external authentication server external to the wireless communication network and that includes an identifier to be presented to the external authentication server.

31-36. (canceled)

37. The authentication server of claim 24, wherein said initiating comprises initiating primary authentication of the wireless communication device with the external authentication server using an anonymous identifier that does not identify the wireless communication device, and wherein the identifier included in the received signaling is a non-anonymous identifier.

38. The authentication server of claim 37, wherein the anonymous identifier is an anonymous Subscription Permanent Identifier, SUPI, and wherein the non-anonymous identifier is a non-anonymous SUPI.

39. The authentication server of claim 24, wherein said initiating comprises initiating primary authentication of the wireless communication device with the external authentication server using a presented identifier that the wireless communication device has presented as identifying the wireless communication device to the wireless communication network, and wherein authenticating the wireless communication device with the wireless communication network based on the identifier included in the received signaling comprises confirming that the presented identifier corresponds to the identifier included in the received signaling.

40. The authentication server of claim 39, wherein said confirming comprises transmitting the presented identifier to network equipment implementing a Unified Data Management, UDM, function, and performing said confirming based on a response received from the network equipment implementing the UDM function.

41. The authentication server of claim 24, wherein the primary authentication is initiated as part of a procedure for registering the wireless communication device with the wireless communication network, and wherein the method further comprises registering the wireless communication device with the wireless communication network based on successful authentication of the wireless communication device with the wireless communication network.

42. The authentication server of claim 24, wherein the wireless communication network is a standalone non-public network.

43. The external authentication server of claim 26, further comprising receiving signaling that triggers the external authentication server to perform the primary authentication of the wireless communication device with the external authentication server, wherein the signaling includes an anonymous identifier for the wireless communication device.

44. The external authentication server of claim 43, wherein the anonymous identifier is an anonymous Subscription Permanent Identifier, SUPI.

45. The external authentication server of claim 26, wherein the identifier included in the transmitted signaling is a non-anonymous identifier.

46. The external authentication server of claim 45, wherein the non-anonymous identifier is a non-anonymous SUPI.

47. The external authentication server of claim 26, wherein the wireless communication network is a standalone non-public network.

48. The network node of claim 28, wherein the request includes an anonymous identifier for the wireless communication device, and wherein the identifier included in the transmitted signaling is a non-anonymous identifier.

49. The network node of claim 48, wherein the anonymous identifier is an anonymous Subscription Permanent Identifier, SUPI, and wherein the non-anonymous identifier is a non-anonymous SUPI.

50. The network node of claim 28, wherein the wireless communication network is a standalone non-public network.

51. The network node of claim 28, wherein the authentication server implements an Authentication Server Function, AUSF, and wherein the network node implements a Network Slice-Specific Authentication and Authorization Function, NSSAAF.

52. The network node of claim 30, wherein the request includes an anonymous identifier for the wireless communication device, and wherein the identifier included in the response is the anonymous identifier for the wireless communication device.

53. The network node of claim 52, wherein the anonymous identifier is an anonymous Subscription Permanent Identifier, SUPI.

54. The network node of claim 50, wherein the processing circuitry is further configured to:
decide, based on a realm part of the anonymous identifier, that primary authentication of the wireless communication device is to be run with the external authentication server external to the wireless communication network.

55. The network node of claim 28, wherein the wireless communication network is a standalone non-public network.
